(19) United States
(12) Patent Application Publication
(10) Pub. No.: US 2006/0032708 A1
(43) Pub. Date: Feb. 16, 2006

(54) Collapsible ladder

(76) Inventor: Graham Kennedy Welsh, St. Kilda Vic (AU)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/511,843

(22) PCT Filed: Apr. 17, 2003
(86) PCT No.: PCT/AU03/00469

§ 371 Date: Jul. 27, 2005

(30) Foreign Application Priority Data
Apr. 19, 2002 (AU) 2002100309

(51) Int. Cl. E06C 1/00

(52) U.S. Cl. 182/159

(57) ABSTRACT

The present invention relates broadly to a collapsible ladder (10) comprising a pair of opposing rails (12A) and (12B) interconnected with a plurality of rails (14A) to (14J). The collapsible ladder (10) can be moved or manipulated from a collapsed condition to an operative condition. In the collapsed condition the opposing pair of rails are (12A/B) locate adjacent or abut one another whereas in the operative position the rails (12A/B) are laterally spaced with the interconnecting rungs (14A) to (14J) being disposed substantially perpendicular thereto. Each of the rungs such as (14A) is at its opposing ends pivotally connected to respective of the opposing pair of rails (12A/B). This pivotal connection between the rungs such as (14A) and rails (12A/B) allows the ladder (10) to move from its operational to collapsed conditions.

### FIELD OF THE INVENTION

The present invention relates broadly to a collapsible ladder.

### BACKGROUND TO THE INVENTION

The traditional domestic or tradesman's ladder is constructed of timber or aluminium alloy. The ladder includes a pair of parallel and spaced apart rails interconnected with a series of rungs. The ladder may be of a single or two-piece construction in which case it is extendible.

The traditional ladder is portable and being relatively lightweight can be transported by hand to its required site of use. The ladder is by hand raised into its vertical but slightly inclined position and leant against the structure to which access is sought. An operator such as a tradesman can then scale the ladder rung by rung.

### SUMMARY OF THE INVENTION

According to the present invention there is provided a collapsible ladder comprising:

a pair of opposing and substantially parallel rails; and

a plurality of rungs being elongate and movably connected at or adjacent opposing ends to respective of the pair of rails whereby the ladder can be moved from an operational condition wherein the parallel rails are laterally separated from one another and disposed generally perpendicular to the rungs to permit access to the ladder, to a collapsed condition wherein the rails on movement relative to the rungs locate adjacent one another to prevent access to the ladder.

Preferably the collapsible ladder also comprises locking means being operatively coupled to the pair of rails to prevent their separation in the collapsed condition. More preferably the locking means includes a locking pin connected to one of the rails and being operable to releasably engage the locking pin with the ladder in the collapsed condition. Even more preferably the locking pin is at one end fixed to the rail and at or adjacent an opposite end has a hole configured to be engaged by a plunger of the locking mechanism. Still more preferably with the ladder in the collapsed condition the locking pin is designed to pass through an opening in an underlying of the rungs together with an aperture in an opposing of the rails wherein the hole in the locking pin is exposed for engagement by the plunger.

Preferably the plurality of rungs are each pivotally connected at opposing ends to respective of the pair of rails to provide racking of the rungs on movement from the operational to the collapsed conditions. More preferably this pivotal connection is provided by a pivot pin coupled to the rail and each of the rungs.

Preferably the pair of rails are each fabricated of channel-section members having their respective flanges aligned with and directed toward one another, the rungs being configured to nest within the channel-section rails with the ladder in the collapsed condition. More preferably the rungs are also fabricated of channel-section members having a width dimension across opposing flanges of less than the corresponding internal width dimension of the rails.

Preferably the collapsible ladder further comprises anchoring means connected to one or both of the pair of rails and being adapted to permanently or temporarily mount the ladder to a structure. More preferably the anchoring means includes a bracket connected at a lower end of one of the rails and adapted to fix to a lower part of the structure, and a locating member connected adjacent an upper end of the one of the rails and adapted to anchor to an elevated part of the structure. Even more preferably the bracket is pivotally coupled to the rail to permit variations in the pitch of the ladder, and the locating member includes a locating pin being adapted to removably locate in a corresponding recess in the structure.

Preferably the collapsible ladder additionally comprises at least one handle connected to one of the rails and positioned such that the ladder in its collapsed condition is evenly weighted about said handle.

Preferably the collapsible ladder at and adjacent its upper end is free of the ladder rungs thus providing unobstructed access between the pair of rails.

Generally the collapsible ladder is fabricated from roll-formed steel.

### BRIEF DESCRIPTION OF THE DRAWINGS

In order to achieve a better understanding of the nature of the present invention a preferred embodiment of a collapsible ladder will now be described, by way of example only, with reference to the accompanying drawings in which:

FIGS. 1 and 2 are schematic illustrations of a collapsible ladder in its collapsed and semi-operational conditions, respectively;

FIG. 3 is a perspective view of the collapsible ladder of FIGS. 1 and 2 in the operational condition erected adjacent a structure;

FIG. 4 is a front elevational view of the collapsible ladder in its collapsed condition;

FIGS. 5 and 6 are front and side elevational views, respectively, of the collapsible ladder in its operative condition;

FIGS. 7a to 7c are detailed views of part of the collapsible ladder together with the locking means in the collapsed, semi-operative and operative conditions;

FIG. 8 is a side elevational view shown in broken detail of the mounting means of the collapsible ladder;

FIG. 9 is a sectional plan view shown in broken detail of the collapsible ladder; and

FIG. 10 is an enlarged sectional view of a pivotal connection of the collapsible ladder.

### DETAILED DESCRIPTION OF THE PREFERRED EMBODIMENT

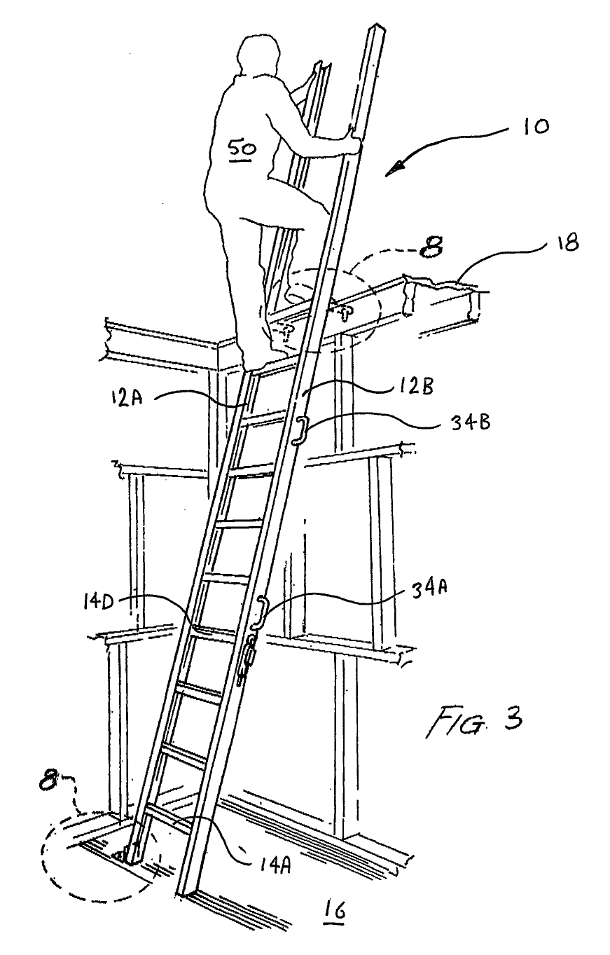

As best shown in FIGS. 1 to 3 there is a collapsible ladder 10 comprising a pair of opposing rails 12A and 12B interconnected with a plurality of rungs 14A to 14J. The collapsible ladder can in this embodiment be moved or manipulated from a collapsed condition to an operative condition as shown in FIGS. 1 and 3, respectively.

In the collapsed condition of FIG. 1 the opposing pair of rails 12A/B locate adjacent or abut one another whereas in the operative position of FIG. 3 the rails 12A/B are laterally spaced with the interconnecting rungs 14A to 14J being disposed substantially perpendicular thereto. In this embodiment the collapsible ladder 10 is erected in a stair well (not designated) of a building structure providing access between a lower floor 16 and an upper floor 18 as will later be described in more detail. One of the rails 12A is fixed at its lower end to the lower floor 16 and anchored adjacent and opposite end to the upper floor 18 whilst the other rail 12B is allowed to move or float relative and parallel to the fixed rail 12A wherein the collapsible ladder 10 is manipulated from the collapsed to the operative positions.

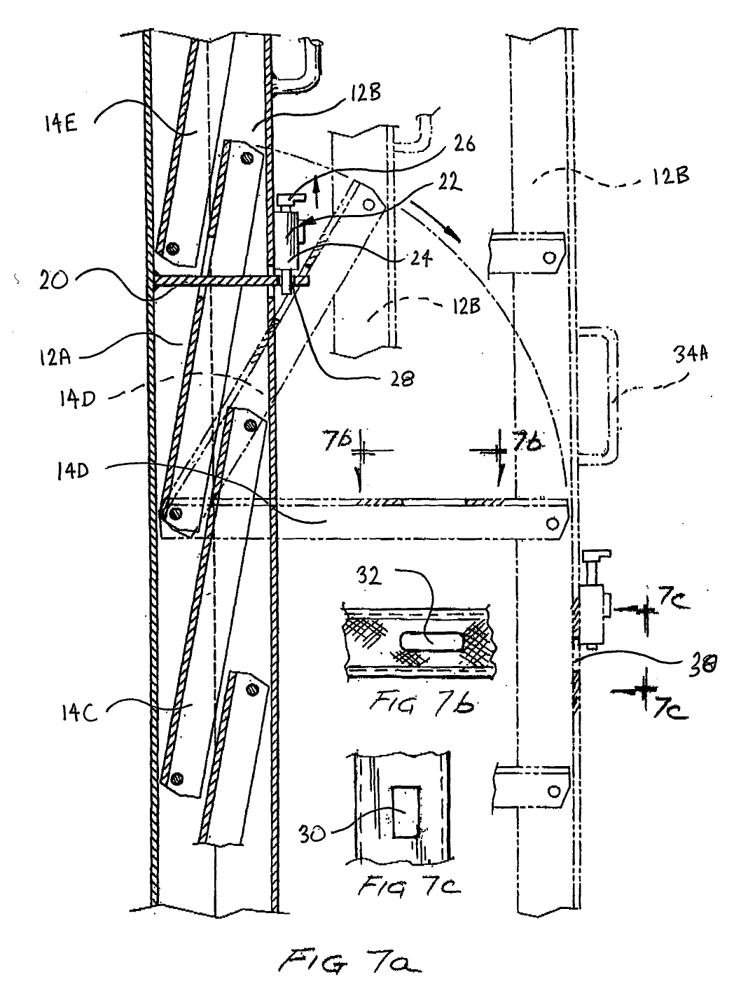

As best shown in FIGS. 7a to 7c each of the rungs such as 14C to 14E is at its opposing ends pivotally connected to respective of the opposing pair of rails 12A/B. This pivotal connection between the rungs such as 14D and rails 12A/B allows the ladder 10 to move from its operational to collapsed conditions with racking of the rungs 14A to 14J. In the collapsed condition the rungs 14A to 14J are nested or housed within the opposing pair of abutting rails 12A/B.

The collapsible ladder 10 also comprises locking means which in this embodiment includes a locking pin 20 and locking mechanism 22. The locking pin 20 is welded or otherwise connected to an inner face of the fixed rail 12A underneath one of the interconnecting rungs 14E. The locking mechanism 22 includes a housing 24 fixed to an outer face of the moveable rail 12B, and a plunger 26 reciprocating within the housing 24 and in this example being key-lockable in an extended position.

The locking pin 20 is of a length greater than the combined width of the abutting pair of rails 12A/B and includes a hole 28 at its free end designed to be engaged by the plunger 26 in its extended position. The movable or floating rail 12B includes an aperture 30 through which the free end of the locking pin 20 passes when the ladder is moved into its collapsed condition. The ladder rung 14D underlying the locking pin 20 also includes an opening 32 through which the locking pin 20 passes on movement of the ladder 10 into its collapsed condition. The plunger 26 of the locking mechanism 22 engages the hole 28 of the locking pin 20 so as to retain the ladder 10 in the collapsed condition. The opening 32 in the underlying rung 14D is shaped in the form of a keyway to allow the sliding passage of the locking pin 20 on closure or collapsing ladder 10.

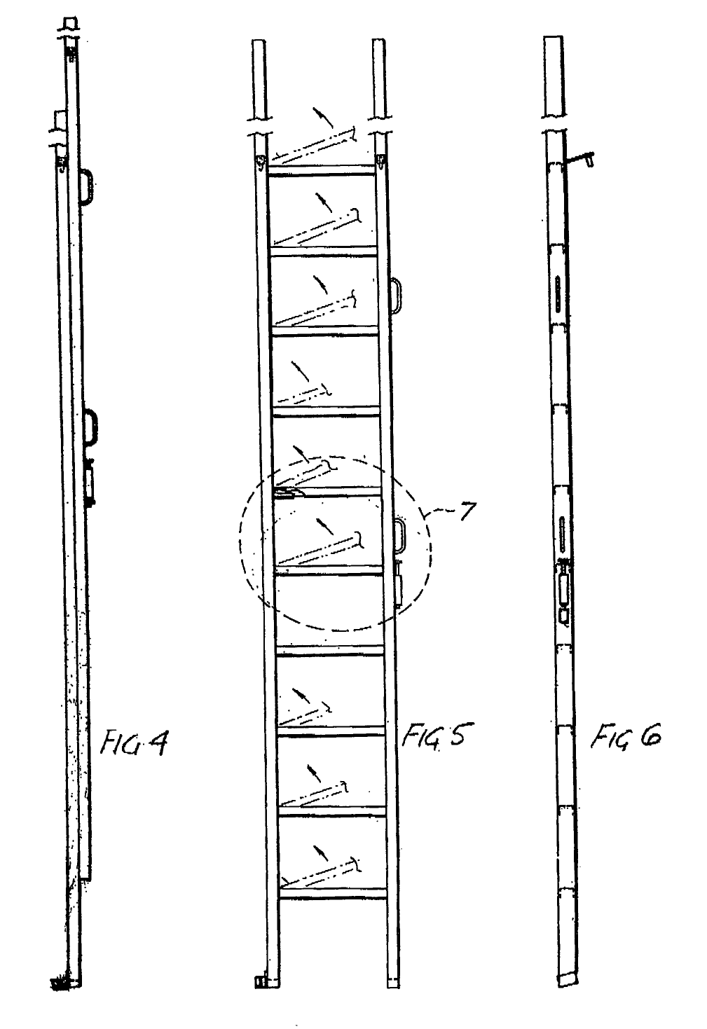

As shown in FIGS. 1 to 6 the collapsible ladder 10 of this example includes a pair of handles 34A and 34B used for manipulation of the ladder between its collapsed and operative conditions. The handles 34A/B are fixed to the floating rail 12B and positioned to allow relatively easy movement of the floating rail 12B between the collapsed and operative positions, and event weighting of the ladder 10 for carrying in its collapsed condition.

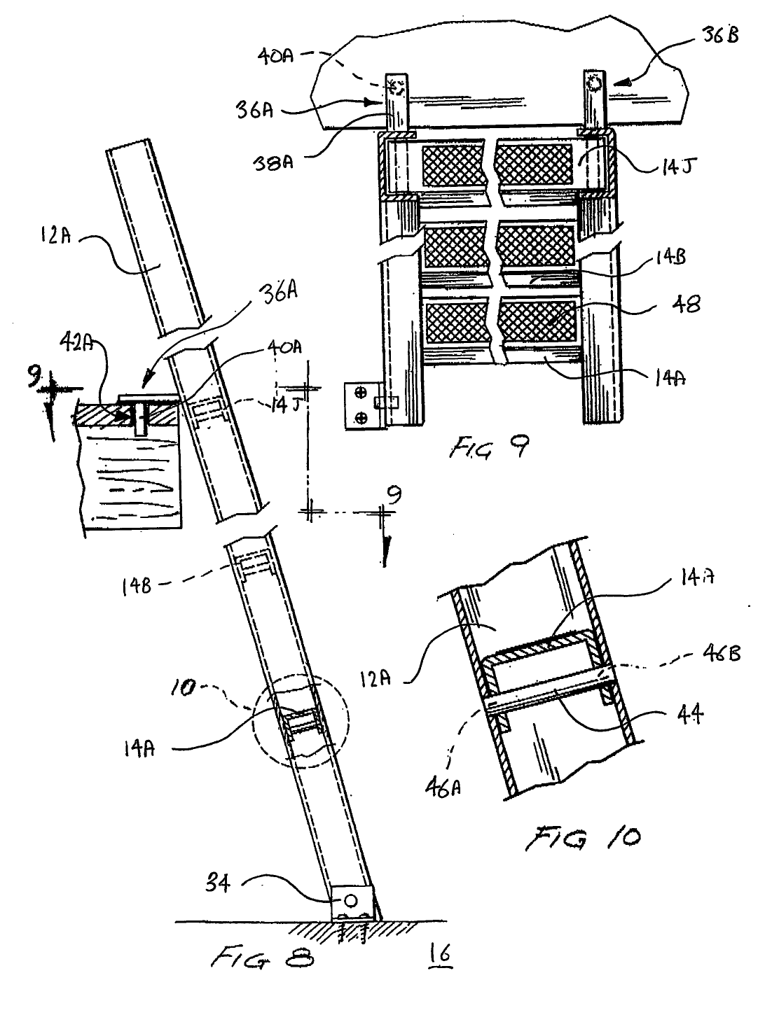

As best shown in FIGS. 8 and 9 the anchoring means for securement of the collapsible ladder 10 in this example includes a bracket 34 and a pair of locating members 36A and 36B. The bracket 34 is pivotally connected to a lower end of the fixed rail 12A and screw fastened to the lower floor 16. The pair of locating members 36A/B include a mounting plate such as 38A welded or otherwise connected to a rear face of the rail 12A and a locating pin or dowel such as 40A mounted underneath and protruding downwardly of the plate 38A. The dowel 40A is designed to removably locate within a corresponding recess 42A formed in the upper floor 18. The locating members 36A/B on engagement with the respective recesses such as 42A effectively mounts or supports the collapsible ladder 10 both in its collapsed and operative positions adjacent the building structure. The pivot bracket 34 and locating members 36A/B of this particular embodiment permit variations in the pitch or inclination of the ladder 10.

FIG. 10 most clearly illustrates the preferred pivotal connection of the rungs such as 14A to the opposing rails 12A/B. The pivotal connection is effected via a pivot pin such as 44 which at opposing ends is swaged or otherwise fixed to respective opposing flanges of in this example the fixed rail 12A. The rung 14A has a pair of clearance holes such as 46A and 46B in its respective opposing flanges and the pivot pin 44 passes through these clearance holes 46A/B to provide the pivotal connection. The ladder rungs such as 14A/B/J of FIGS. 9 and 10 also include a non-skid layer such as 48 applied to the tread of each of the rungs such as 14A.

The rails 12A/B and rungs 14A to 14J of this embodiment are fabricated of channel-section members. The rails 12A/B are arranged so that their respective flanges are aligned with and directed toward one another. The rungs such as 14A have a width dimension across opposing flanges of slightly less than the corresponding internal width dimension of the rails 12A/B. The rungs 14A to 14J thus pivot and nest within the opposing pair of rails 12A/B. The web of the channel-section rungs 14A to 14J faces upward and forms the tread for each of the rungs such as 14A. The channel-section rails 12A/B and rungs 14A to 14J are fabricated from roll formed mild steel which is preferably coated in a corrosion-resistant product.

In order to further assist in understanding the invention, operation of this embodiment of the collapsible ladder 10 will now be explained in terms of the following general steps:

1. the collapsible ladder 10 is carried by the handles 34A/B in its collapsed condition to the site at which it will be erected;

2. the collapsible ladder 10 is screw fastened to the lower floor 16 using the bracket 34 of the fixed rail 12A, and the locating member 36A of the fixed rail 12A is positioned in a pre-drilled hole 42A of the upper floor 18;

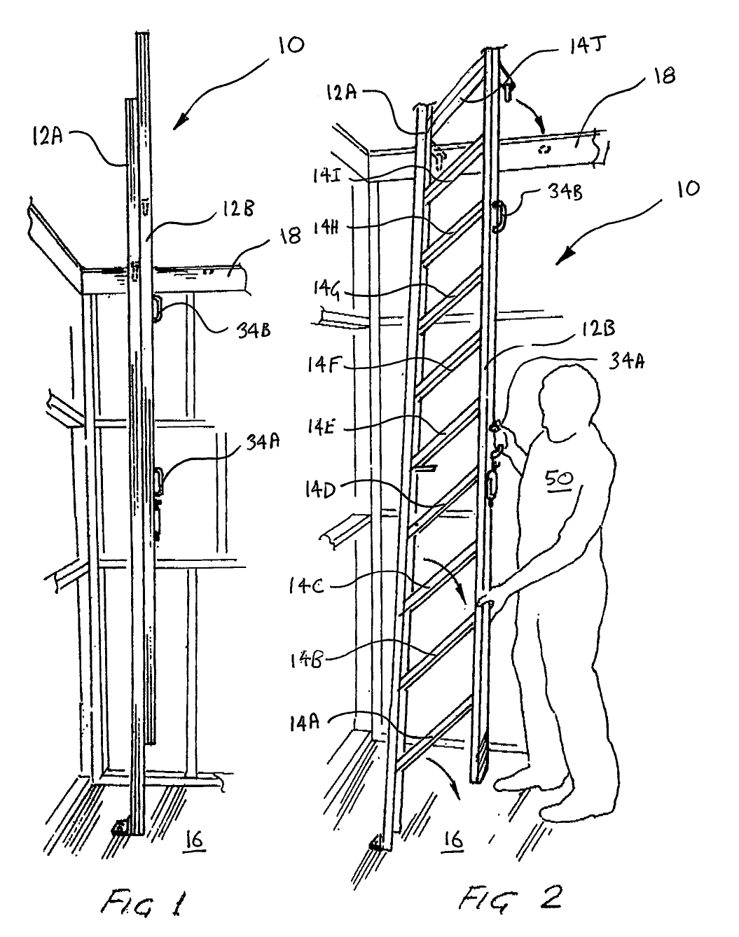

3. the locking mechanism 22 is unlocked and the plunger 26 retracted from engagement with the locking pin 20 to permit movement of the floating rail 12B away from the fixed rail 12A as depicted in FIG. 2; and

4. the collapsible ladder 10 is moved into the operative position wherein a lower end of the floating rail 12B abuts the lower floor 16 and the other locating member 36B adjacent the upper end of the floating rail 12B locates within the other pre-drilled hole in the upper floor 18.

In the operative position the collapsible ladder 10 provides access for a person such as 50 to scale the ladder 10 via the rungs 14A to 14J in a conventional manner. The ladder 10 at and adjacent its upper end is free of ladder rungs and thus provides unobstructed access between the pair of rails 12A/B.

In order to move the ladder 10 from its operative to collapsed conditions, the procedure outlined above involving steps 1 to 4 is essentially performed in reverse. The floating rail 12B is swung via at least the handle 34A upwardly and toward the fixed rail 12A. The ladder 10 in its collapsed condition with the rails 12A/B abutting one another houses the interconnecting rungs 14A to 14J which are held in this collapsed condition by engagement of the plunger 26 with the locking pin 20. In this collapsed condition access to the ladder which remains in-situ is prevented.

It should be appreciated that the collapsible ladder may be installed temporarily as described or may form a permanent fixture on for example tanks, vats, ships, freight carriages and other locations where access to dangerous or secure areas is restricted. The ladder may also be incorporated in scaffolding to prevent access by unauthorised persons, such as children, when the scaffolding is not in use.

Now that a preferred embodiment of the present invention has been described in some detail it will be apparent to those skilled in the art that the collapsible ladder of this embodiment has at least the following advantages:

1. a ladder can with relative ease be manipulated from an operative condition to a relatively compact and transportable collapsed condition;

2. the collapsible ladder can remain in-situ whilst being locked in the collapsed condition to prevent unauthorised access;

3. the collapsible ladder can be adapted for use in a range of applications for both permanent and temporary location.

Those skilled in the art will appreciate the invention described herein is susceptible to variations and modifications other than those specifically described. For example, the rungs need not be pivotally connected to the rails to permit collapsing of the ladder but rather a sliding connection may provide the same functionality. The various components of the collapsible ladder are not limited to those described but for example extend to members of different geometry and materials of construction.

All such variations and modifications are to be considered within the scope of the present invention the nature of which is to be determined from the foregoing description.

All such variations and modifications are to be considered within the scope of the present invention the nature of which is to be determined from the foregoing description.

1. A collapsible ladder comprising:
a pair of opposing and substantially parallel rails;
a plurality of rungs being elongate and pivotally connected at or adjacent opposing ends to respective of the pair of rails whereby the ladder can be moved from an operational condition wherein the parallel rails are laterally separated from one another and disposed generally perpendicular to the rungs to permit access to the ladder, to a collapsed condition wherein the rails on movement relative to the rungs locate adjacent one another to prevent access to the ladder; and
locking means being operatively coupled to the pair of rails to prevent their separation in the collapsed condition, the locking means including a locking pin rigidly connected to one of the rails and a locking mechanism mounted to another of the rails and being operable to releasably engage the locking pin with the ladder in the collapsed condition.

2. A collapsible ladder as defined in claim 1 wherein the locking pin is at one end integrally connected to the rail and at or adjacent an opposite end has a hole configured to be engaged by a plunger of the locking mechanism.

3. A collapsible ladder as defined in claim 2 wherein, with the ladder in the collapsed condition, the locking pin is designed to pass through an opening in an underlying of the rungs together with an aperture in an opposing of the rails wherein the hole in the locking pin is exposed for engagement by the plunger.

4. A collapsible ladder as defined in any one of the preceding claims wherein the collapsible ladder at and adjacent its upper end is free of the ladder rungs for a height substantially greater than shoulder height of a person and providing unobstructed access between the pair of rails.

5. A collapsible ladder as defined in any one of the preceding claims further comprising anchoring means connected to one or both of the pair of rails and being adapted to permanently or temporarily mount the ladder to a structure.

6. A collapsible ladder as defined in claim 5 wherein the anchoring means includes a bracket connected at a lower end of one of the rails and adapted to fix to a lower part of the structure, and a locating member connected adjacent an upper end of the one of the rails and adapted to anchor to an elevated part of the structure.

7. A collapsible ladder as defined in claim 6 wherein the bracket is pivotally coupled to the rail to permit variations in the pitch of the ladder, and the locating member includes a locating pin being adapted to removably locate in a corresponding recess in the structure.

8. A collapsible ladder as defined in any one of the preceding claims wherein the pivotal connection between the rungs and the rails is provided by a pivot pin coupled to the rail and each of the rungs.

9. A collapsible ladder as defined in any one of the preceding claims wherein the pair of rails are each fabricated of channel-section members having their respective flanges aligned with and directed toward one another, the rungs being configured to nest within the channel-section rails with the ladder in the collapsed condition.

10. A collapsible ladder in claim 9 wherein the rungs are also fabricated of channel-section members having a width dimension across opposing flanges of less than the corresponding internal width dimension of the rails.

11. A collapsible ladder as defined in any one of the preceding claims additionally comprising at least one handle connected to one of the rails and positioned such that the ladder in its collapsed condition is evenly weighted about said handle.

12. A collapsible ladder as defined in any one of the preceding claims wherein the collapsible ladder is fabricated from roll-formed steel.
